(19) United States
(12) Patent Application Publication
(10) Pub. No.: US 2022/0385009 A1
(43) Pub. Date: Dec. 1, 2022

(54) COAXIAL CABLE AND CONNECTOR WITH ADAPTER TO FACILITATE ASSEMBLY

(71) Applicant: CommScope Technologies LLC, Hickory, NC (US)

(72) Inventors: Maureen Ho, Murphy, TX (US); ChuanHui Liu, Suzhou (CN); Hongjuan An, Suzhou (CN)

(21) Appl. No.: 17/729,307

(22) Filed: Apr. 26, 2022

Related U.S. Application Data
(60) Provisional application No. 63/192,890, filed on May 25, 2021.

(51) Int. Cl. H01R 24/54; H01R 43/00

(52) U.S. Cl. CPC H01R 24/542; H01R 43/00

(57) ABSTRACT

A coaxial cable-connector assembly includes:
(a) a coaxial cable comprising an inner conductor, a dielectric layer circumferentially overlying the inner conductor, an outer conductor circumferentially overlying the inner conductor, and a polymeric jacket circumferentially overlying the outer conductor;
(b) a connector adapter, comprising an inner contact that is electrically connected to the inner conductor, an outer sleeve that is in electrical contact with the outer conductor, and a dielectric spacer interposed between the inner contact and the outer sleeve, and
(c) a coaxial connector having an outer connector body, the outer connector body having a mating end configured to mate with a mating connector and an adapter ring, the adapter ring configured to engage and electrically connect to the outer sleeve.

### RELATED APPLICATION

The present application claims priority from and the benefit of U.S. Provisional Patent Application No. 63/192,890, filed May 25, 2021, the disclosure of which is hereby incorporated herein by reference in full.

### FIELD OF THE INVENTION

The present invention is directed generally to electrical cable connectors, and more particularly to coaxial connectors for electrical cable.

### BACKGROUND OF THE INVENTION

Coaxial cables are commonly utilized in RF communications systems. A typical coaxial cable includes an inner conductor, an outer conductor, a dielectric layer that separates the inner and outer conductors, and a jacket that covers the outer conductor. Coaxial cable connectors may be applied to terminate coaxial cables, for example, in communication systems requiring a high level of precision and reliability.

Coaxial connector interfaces provide a connect/disconnect functionality between (a) a cable terminated with a connector bearing the desired connector interface and (b) a corresponding connector with a mating connector interface mounted on an electronic apparatus or on another cable. Typically, one connector will include a structure such as a pin or post connected to an inner conductor of the coaxial cable and an outer conductor connector body connected to the outer conductor of the coaxial cable these are mated with a mating sleeve (for the pin or post of the inner conductor) and another outer conductor connector body of a second connector. Coaxial connector interfaces often utilize a threaded coupling nut or other retainer that draws the connector interface pair into secure electro-mechanical engagement when the coupling nut (which is captured by one of the connectors) is threaded onto the other connector. Typically, the processes of joining the connector with coaxial cable vary for different connector designs and development efforts are needed to optimize the process to meet the electrical and mechanical requirement.

There exist many different types of radio frequency (RF) coaxial connectors in the market today. This number continues to grow as requirements change and higher performance is needed over a broader range of frequencies. As demand for coaxial cable assemblies with increasingly different permutations of these connector types grows and may vary from region to region or from customer to customer, fulfilling customer demand can at times be challenging.

### SUMMARY OF THE INVENTION

As a first aspect, embodiments of the invention are directed to a coaxial cable-connector assembly. The assembly comprises:
(a) a coaxial cable comprising an inner conductor, a dielectric layer circumferentially overlying the inner conductor, an outer conductor circumferentially overlying the inner conductor, and a polymeric jacket circumferentially overlying the outer conductor;
(b) a connector adapter, comprising an inner contact that is electrically connected to the inner conductor, an outer sleeve that is in electrical contact with the outer conductor, and a dielectric spacer interposed between the inner contact and the outer sleeve, and
(c) a coaxial connector having an outer connector body, the outer connector body having a mating end configured to mate with a mating connector and an adapter ring, the adapter ring configured to engage and electrically connect to the outer sleeve.

As a second aspect, embodiments of the invention are directed to a method of constructing a coaxial cable-connector assembly, comprising:
(a) providing a coaxial cable comprising an inner conductor, a dielectric layer circumferentially overlying the inner conductor, an outer conductor circumferentially overlying the inner conductor, and a polymeric jacket circumferentially overlying the outer conductor;
(b) attaching a connector adapter to the coaxial cable, the connector adapter including an inner contact that is electrically connected to the inner conductor, an outer sleeve that is in electrical contact with the outer conductor, and a dielectric spacer interposed between the inner contact and the outer sleeve; then
(c) attaching a coaxial connector to the connector adapter, the coaxial connector having an outer connector body with a mating end configured to mate with a mating connector and an adapter ring, the adapter ring engaging and electrically connecting to the outer sleeve.

As a third aspect, embodiments of the invention are directed to a coaxial cable subassembly comprising:
(a) a coaxial cable comprising an inner conductor, a dielectric layer circumferentially overlying the inner conductor, an outer conductor circumferentially overlying the inner conductor, and a polymeric jacket circumferentially overlying the outer conductor;
(b) a connector adapter, comprising an inner contact that is electrically connected to the inner conductor, an outer sleeve that is in electrical contact with the outer conductor, and a dielectric spacer interposed between the inner contact and the outer sleeve, wherein the outer sleeve includes a wider portion that encircles the outer conductor and a narrower portion configured to be received in an outer connector body of a coaxial connector.

### BRIEF DESCRIPTION OF THE FIGURES

FIG. 1 is a perspective view of an adapter that can be used to interconnect a coaxial cable with a coaxial connector in accordance with embodiments of the invention.

FIG. 2A is a section view of the adapter of FIG. 1.

FIG. 2B is an exploded section view of the adapter of FIG. 1.

FIG. 3 is a side view of a coaxial cable for use with the adapter of FIG. 1.

FIG. 4 is a section view of the coaxial cable of FIG. 3.

FIG. 5A is a section view of the adapter of FIG. 1 attached to the coaxial cable of FIG. 3 with the boot omitted.

FIG. 5B is an enlarged section view of the adapter of FIG. 1 attached to the coaxial cable of FIG. 3 with the boot included.

FIG. 6 is an exploded side view of the coaxial cable and adapter of FIG. 5 with two exemplary coaxial connectors.

FIG. 7A is an assembled side view of the coaxial cable and adapter of FIG. 6 with one of the coaxial connectors of FIG. 6.

FIG. 7B is an assembled section view of coaxial cable, adapter and connector of FIG. 7A.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

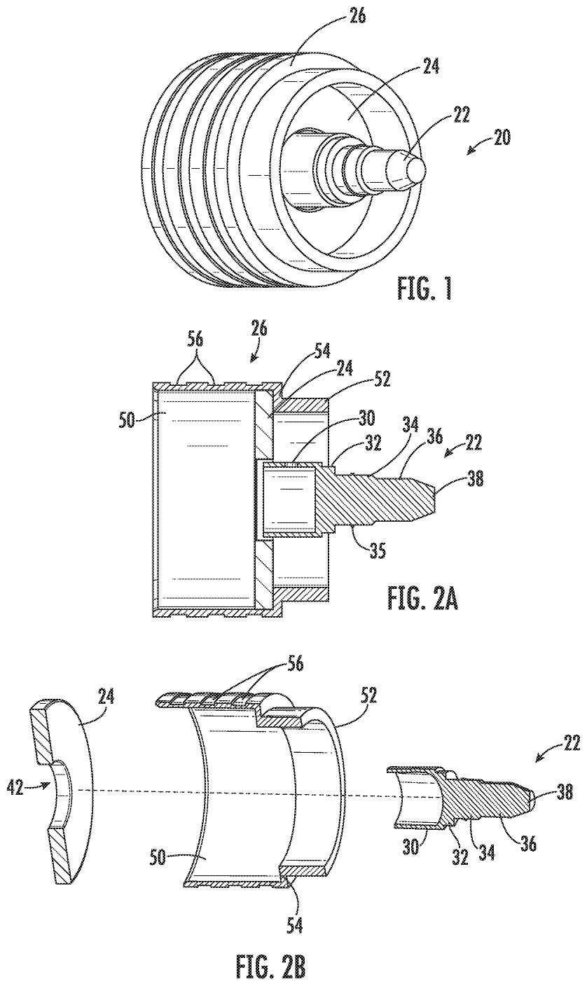

Referring now to the drawings, an adapter for facilitating the attachment of a coaxial cable to a coaxial connector, designated broadly at 20, is shown in FIGS. 1, 2A and 2B. The adapter 20 includes an inner contact 22, a dielectric spacer 24, and an outer sleeve 26. These components are discussed in detail below.

The inner contact 22 includes a cylindrical base 30 and three sequentially narrower sections 32, 34, 36 that lead to a frustoconical tip 38. A circumferential ridge 35 is present in the section 34. As can be seen in FIGS. 2A and 2B, the interior of the inner contact 22 is hollow in the base 30. The dielectric spacer 24 is generally disc-shaped, with an interior hole 42 that receives the inner contact 22.

The outer sleeve 26 has a wider portion 50 and a narrower portion 52. As can be seen in FIG. 2A, the dielectric spacer 24 fits within the wider portion 50 and abuts a shoulder 54 between the wider and narrower portions 50, 52. The outer surface of the wider portion 50 has circumferential grooves 56; however, the outer surface of the narrower portion 52 is smooth.

The inner and outer contacts 22, 26 are typically formed from a metallic material, such as brass. The dielectric spacer 24 is typically formed of a dielectric material, such as a polymeric material.

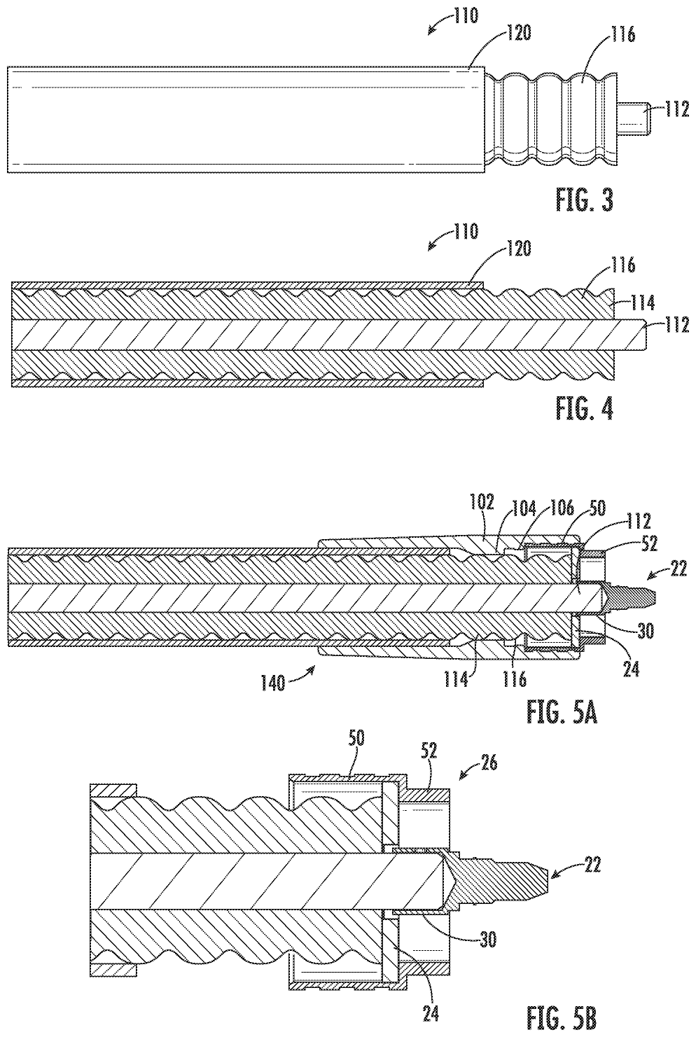

FIGS. 3 and 4 illustrate a coaxial cable 110. The cable 110 includes an inner conductor 112, a dielectric layer 114 that circumferentially overlies the inner conductor 112, an annularly corrugated outer conductor 116 that circumferentially overlies the dielectric layer 114, and a polymeric cable jacket 120 that circumferentially overlies the outer conductor 116. These components will be well-known to those of skill in this art and need not be described in detail herein.

FIGS. 5A and 5B show the coaxial cable 110 connected with the adapter 20. The forward end of the inner conductor 112 is received in the base 30 of the inner contact 22. The forward ends of the dielectric layer 114 and the outer conductor 116 abut the rear surface of the dielectric spacer 24. The wider portion 50 of the outer contact 26 is positioned radially outwardly of the outer conductor 116. A boot 102 (typically formed of a flexible material, and in some instances a shrinkable material) fits over the end portion of the jacket 120, the exposed portion of the outer conductor 116, and the wider portion 50 of the outer contact 26. The boot 102 has a shoulder 104 between the forward end of the jacket 120 and the rear end of the outer contact 26, and ridges 106 on its inner surface.

The inner contact 22 of the adapter 20 may be attached to the inner conductor 112 via a press fit joint, soldering, or the like. The outer contact 26 of the adapter 20 may be attached to the outer conductor 116 via soldering, welding, crimping or the like. Once the adapter 20 has been attached to the coaxial cable 110, the boot 102 can be slid into place as shown in FIG. 5A. The shoulder 104 of the boot 102 may abut the rear end of the wider portion 50, and the ridges 106 may fit within the grooves 56 of the wider portion 50.

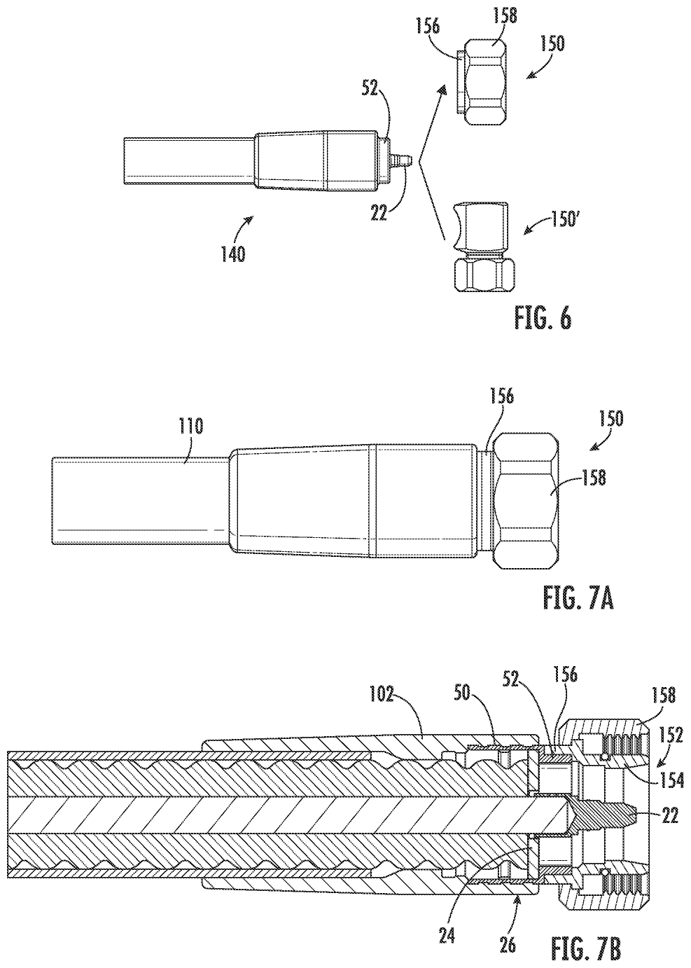

The adapter 20, cable 110 and boot 102 form an intermediate subassembly 140 that can then be employed to construct a coaxial cable-connector assembly 150 that includes one of any number of coaxial connector varieties. Two examples of connectors are shown in FIGS. 6 and 7; an inline connector 150 and a right-angle connector 150′. The ensuing discussion will reference the inline connector 150, but is equally applicable to the right angle connector 150′ or other coaxial connectors.

The connector 150 includes an outer connector body 152. The outer connector body 152 has a mating end 154 that enables it to mate with the outer connector body of a mating connector, and an adapter ring 156. The mating end 154 can have any configuration known to be suitable for RF coaxial cables, such as DIN 7/16, 4.3/10, N-type, and the like. Typically, the mating end 154 will include a coupling member or apparatus (such as the coupling nut 158 shown herein, or a “push-pull” mechanism) to enable the connector 150 to be mated and secured to a mating connector.

As can be envisioned in FIGS. 6, 7A and 7B, the adapter ring 156 is sized to receive therewithin the wider portion 50 of the outer contact 26 of the adapter 20. The wider portion 50 may be coupled to the adapter ring 156 via a mechanical joint (e.g., a press-fit or interference-fit joint, a threaded joint, or a crimped joint), or a metallurgical joint (e.g., a soldered or welded joint).

In some embodiments, the connector 150 may include an inner contact that is coupled to the inner contact 22 of the adapter 20. The inner contact may be mechanically or metallurgically coupled to the inner contact 22. In other embodiments (such as the embodiment of FIGS. 7A and 7B), the connector 150 may have no separate inner contact, such that the inner contact 22 serves as the inner contact that directly mates with the inner contact of a mating connector.

In embodiments in which the connector 150 includes an inner contact, a dielectric spacer may be present between the inner contact of the connector 150 and the outer connector body 152. In such embodiments, the connector 150 may be provided as a unitary component that can be coupled quickly to the adapter 20.

It will be understood that the adapter 20 can enable connectors 150 of virtually any configuration to be attached quickly and easily to the cable 110. Thus, a manufacturer may produce only a few sizes of coaxial cables 110, each with an accompanying adapter 20 of appropriate size. These relatively few coaxial cables may then be connected with a much larger number of connector types. Thus, manufacturing advantages may be realized by reducing the number of different processes to produce many different cable-connector combinations, and by providing what is essentially a “made-to-order” technique to provide virtually any cable-connector combination to a customer or user.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A coaxial cable-connector assembly, comprising:
(a) a coaxial cable comprising an inner conductor, a dielectric layer circumferentially overlying the inner conductor, an outer conductor circumferentially overlying the inner conductor, and a polymeric jacket circumferentially overlying the outer conductor;
(b) a connector adapter, comprising an inner contact that is electrically connected to the inner conductor, an outer sleeve that is in electrical contact with the outer conductor, and a dielectric spacer interposed between the inner contact and the outer sleeve, and
(c) a coaxial connector having an outer connector body, the outer connector body having a mating end configured to mate with a mating connector and an adapter ring, the adapter ring configured to engage and electrically connect to the outer sleeve.

2. The coaxial cable-connector assembly defined in claim 1, wherein the outer sleeve and the outer connector body are joined via an interference fit joint.

3. The coaxial cable-connector assembly defined in claim 1, wherein the inner contact of the connector adapter is a first inner contact, and wherein the coaxial connector includes a second inner contact that engages and electrically connects with the first inner contact.

4. The coaxial cable-connector assembly defined in claim 3, wherein the coaxial connector includes an insulator interposed between the second inner contact and the outer connector body.

5. The coaxial cable-connector assembly defined in claim 1, further comprising a boot that partially overlies the jacket, the outer conductor and the outer sleeve of the connector adapter.

6. The coaxial cable-connector assembly defined in claim 1, wherein the outer sleeve includes a wider portion that encircles the outer conductor and a narrower portion that is received in the outer connector body.

7. The coaxial cable-connector assembly defined in claim 1, wherein the outer sleeve is metallurgically attached to the outer conductor.

8. The coaxial cable-connector assembly defined in claim 1, wherein the outer sleeve is mechanically attached to the outer conductor.

9. The coaxial cable-connector assembly defined in claim 1, wherein the coaxial connector includes no inner contact, such that the inner contact of the adapter is configured to engage an inner contact of a mating connector.

10. A method of constructing a coaxial cable-connector assembly, comprising:
(a) providing a coaxial cable comprising an inner conductor, a dielectric layer circumferentially overlying the inner conductor, an outer conductor circumferentially overlying the inner conductor, and a polymeric jacket circumferentially overlying the outer conductor;
(b) attaching a connector adapter to the coaxial cable, the connector adapter including an inner contact that is electrically connected to the inner conductor, an outer sleeve that is in electrical contact with the outer conductor, and a dielectric spacer interposed between the inner contact and the outer sleeve; then
(c) attaching a coaxial connector to the connector adapter, the coaxial connector having an outer connector body with a mating end configured to mate with a mating connector and an adapter ring, the adapter ring engaging and electrically connecting to the outer sleeve.

11. The method defined in claim 10, wherein step (c) comprises joining the outer sleeve and the outer connector body via an interference fit joint.

12. The method defined in claim 10, wherein the inner contact of the connector adapter is a first inner contact, and wherein the coaxial connector includes a second inner contact that engages and electrically connects with the first inner contact.

13. The method defined in claim 12, wherein the coaxial connector includes an insulator interposed between the second inner contact and the outer connector body.

14. The method defined in claim 10, wherein the coaxial cable further comprises a boot, and wherein the method further comprises sliding the boot along the cable to a position in which the boot at least partially overlies the jacket, the outer conductor and the outer sleeve of the connector adapter.

15. The method defined in claim 10, wherein the outer sleeve includes a wider portion that encircles the outer conductor and a narrower portion received in the outer connector body.

16. The method defined in claim 10, wherein step (b) comprises attaching the outer sleeve to the outer conductor metallurgically or mechanically.

17. The method defined in claim 10, wherein the coaxial connector is a first of a plurality of coaxial connectors that are each configured to mate with the connector adapter, and wherein step (c) comprises selecting the first coaxial connector from the plurality of coaxial connectors based on characteristics of the mating connector.

18. The method defined in claim 10, wherein the coaxial connector includes no inner contact, such that the inner contact of the adapter is configured to engage an inner contact of a mating connector.

19. A coaxial cable subassembly, comprising:
(a) a coaxial cable comprising an inner conductor, a dielectric layer circumferentially overlying the inner conductor, an outer conductor circumferentially overlying the inner conductor, and a polymeric jacket circumferentially overlying the outer conductor;
(b) a connector adapter, comprising an inner contact that is electrically connected to the inner conductor, an outer sleeve that is in electrical contact with the outer conductor, and a dielectric spacer interposed between the inner contact and the outer sleeve, wherein the outer sleeve includes a wider portion that encircles the outer conductor and a narrower portion configured to be received in an outer connector body of a coaxial connector.

20. The coaxial cable subassembly defined in claim 19, further comprising a boot that partially overlies the jacket, the outer conductor and the outer sleeve of the connector adapter.
